(19) United States
(12) Patent Application Publication
(10) Pub. No.: US 2012/0256353 A1
(43) Pub. Date: Oct. 11, 2012

(54) PATTERN TRANSFER APPARATUS AND PATTERN TRANSFER METHOD

(75) Inventors: Mitsuru HASEGAWA, Hitachi (JP); Hajime Murakami, Kasama (JP); Akihiro Miyauchi, Hitachi (JP); Masahiko Ogino, Hitachi (JP)

(73) Assignee: Hitachi, Ltd.

(21) Appl. No.: 13/414,959

(22) Filed: Mar. 8, 2012

(30) Foreign Application Priority Data
Apr. 8, 2011 (JP) 2011-086252

(51) Int. Cl. B29C 59/02; B29C 71/04; B29C 71/00; B29C 37/00; B29C 59/04

(52) U.S. Cl. 264/405; 425/135; 425/72.1; 264/40.1

(57) ABSTRACT

A pattern transfer apparatus for pressing a mold having a fine concave/convex pattern onto a transferred material, peeling off the mold from the transferred material, and transferring the concave/convex pattern onto a surface of the transferred material includes: a pretreatment mechanism configured to perform a predetermined surface treatment to at least one of the mold and the transferred material before the concave/convex pattern is transferred; an information recording mechanism configured to record information of the surface treatment performed by the pretreatment mechanism at a position associated with an area of the transferred material where the concave/convex pattern is transferred onto the area; an interpretation mechanism configured to read the recorded information; and an after-treatment mechanism configured to perform a predetermined after-treatment to the area where the concave/convex pattern is transferred, based on the information interpreted by the interpretation mechanism.

### BACKGROUND OF THE INVENTION

1. Field of the Invention

The present invention relates to a pattern transfer apparatus and a pattern transfer method for transferring a fine concave/convex pattern onto a transferred material by a nanoimprint method.

2. Description of the Related Art

Recently, with respect to a reflection prevention film of a crystal display, an optical component of a light-guide plate and the like, a bio-device of a cell culture sheet and the like, a solar battery, and an electronic device of a light emission device and the like, in order to improve those performances and bring out those desired functions, a member where a fine concave/convex pattern is formed on surfaces of various materials is used.

Conventionally as a technology for forming the fine concave/convex pattern, a nanoimprint technology is known (for example, see a specification of U.S. Pat. No. 5,259,926, a specification of U.S. Pat. No. 5,772,905, and Non-Patent Document 1 of S. Y. chou et al., Appl. Phys. Lett., vol. 67, p. 3114 (1995)).

This nanoimprint technology is a technology of transferring the fine concave/convex pattern of a nanometer size by imprinting a mold having the same onto a resin applied on a surface of a substrate. In this connection, a transfer technology of the U.S. Pat. No. 5,259,926, the U.S. Pat. No. 5,772,905, and the Non-Patent Document 1 is a technology of pressing like a stamp a flat plate-like mold onto a resin.

Furthermore, a transfer technology where a roller type of a mold is used is also known (for example, see Japanese Patent Laid-Open Publication No. 2006-326948 and Non-Patent Document 2 of Hua Tan et al., J. Vac. Sci. Tecnol. B16(6), p. 3926 (1998)). According to this transfer technology, since it is possible to continuously supply a transferred material to a mold continuously rotating, a transfer process thereof can be processed at high speed in comparison with a stamp-system transfer technology of using the flat plate-like mold (for example, see the U.S. Pat. No. 5,259,926, the U.S. Pat. No. 5,772,905, and the Non-Patent Document 1).

Furthermore, the inventors have disclosed a transfer technology of using a belt-like mold (see Japanese Patent Laid-Open Publication Nos. 2009-158731 and 2009-078521). According to this transfer technology, the belt-like mold is supplied to a transferred material; thereby, it is possible to make a transfer process processed at high speed and further improve a pattern transfer accuracy in comparison with the stamp-system transfer technology of using the flat plate-like mold (for example, see the U.S. Pat. No. 5,259,926, the U.S. Pat. No. 5,772,905, and the Non-Patent Document 1).

Incidentally, with respect to the nanoimprint technology, generally, in order to prevent a mold and a transferred material from adhering with each other, a mold-releasing layer is formed in an entire mold in advance. With respect to the mold-releasing layer, a material configuring the mold-releasing layer drops off as the pattern transfer is repeated and a mold-releasing ability is gradually reduced. Therefore, when a transfer defect or clogging of the mold occurs, it is necessary to replace the mold with a new one or perform a collection treatment of newly forming a mold-releasing layer on a surface of the mold.

On the other hand, according to the transfer technology of the Japanese Patent Laid-Open Publication Nos. 2009-158731 and 2009-078521, a non-reactive mold-releasing agent not being covalently bonded to a chemical species on a mold surface but adsorbing on the mold surface is sequentially supplied to the mold surface after a pattern transfer is repeated a plurality of times. Thus according to the transfer technology, it is possible to prevent the mold-releasing ability of a mold from being reduced and prevent the transfer defect and clogging of the mold.

Whereas, with respect to a mold-releasing treatment of supplying a non-reactive mold-releasing agent to a mold surface (see the Japanese Patent Laid-Open Publication Nos. 2009-158731 and 2009-078521), the agent of the mold surface moves to a surface of a transferred material every time when the pattern transfer is performed. Then a movement amount of the non-reactive mold-releasing agent, in other words, an adhesion amount of the agent to the surface of the transferred material is different between just after the agent being supplied to the mold surface and after a plurality of times of the pattern transfer being repeatedly transferred. Therefore, there is a fear that a fluctuation occurs in a performance of a product (component) obtained by the pattern transfer being performed onto the transferred material.

Furthermore, not limited to the mold-releasing treatment of the mold surface thus described, similarly, also when the pattern transfer is being continuously performed and a predetermined treatment is performed to any of the mold and the transferred material, there is a fear that a fluctuation occurs in the performance of a product (component) obtained.

### SUMMARY OF THE INVENTION

Consequently, a problem of the present invention is to provide a pattern transfer apparatus and a pattern transfer method that can stabilize the performance of a product (component) obtained by performing a pattern transfer to a transferred material.

The invention for solving the problem is a pattern transfer apparatus for pressing a mold having a fine concave/convex pattern onto a transferred material, peeling off the mold from the transferred material, and transferring the concave/convex pattern onto a surface of the transferred material; and the pattern transfer apparatus comprises: a pretreatment mechanism configured to perform a predetermined surface treatment to at least one of the mold and the transferred material before the concave/convex pattern is transferred; an information recording mechanism configured to record information of the surface treatment performed by the pretreatment mechanism at a position associated with an area of the transferred material where the concave/convex pattern is transferred onto the area; an interpretation mechanism configured to read the recorded information; and an after-treatment mechanism configured to perform a predetermined after-treatment to the area where the concave/convex pattern is transferred, based on the information interpreted by the interpretation mechanism.

Furthermore, the invention for solving the problem is a pattern transfer method for pressing a mold having a fine concave/convex pattern onto a transferred material, peeling off the mold from the transferred material, and transferring the concave/convex pattern onto a surface of the transferred material; and the pattern transfer method comprising: a process of performing a predetermined surface treatment to at least one of the mold and the transferred material before the concave/convex pattern is transferred; an information recording process of recording information of the surface treatment performed by the pretreatment process at a position associated with an area of the transferred material where the concave/convex pattern is transferred onto the area; an interpretation process of reading the recorded information; and an after-treatment process of performing a predetermined after-treatment to the area where the concave/convex pattern is transferred, based on the information interpreted by the interpretation process.

According to the invention, it is possible to provide the pattern transfer apparatus and the pattern transfer method that can stabilize the performance of a product (component) obtained by transferring the concave/convex pattern onto the transferred material.

### BRIEF DESCRIPTION OF THE DRAWINGS

FIG. 1 is a configuration illustration schematically showing a pattern transfer apparatus of a first embodiment of the present invention.

FIG. 2 is a partial perspective view showing a periphery of an information recording mechanism of the pattern transfer apparatus in FIG. 1.

FIG. 3 is a partial perspective view of a pattern transfer apparatus showing a modification example of the information recording mechanism shown in FIG. 2.

FIG. 4 is a configuration illustration schematically showing a pattern transfer apparatus of a second embodiment of the invention.

FIG. 5 is a partial perspective view showing a periphery of an information recording mechanism of the pattern transfer apparatus in FIG. 4.

FIG. 6 is a partial perspective view of a pattern transfer apparatus showing a modification example of the information recording mechanism shown in FIG. 5.

FIG. 7 is a configuration illustration schematically showing a pattern transfer apparatus of a third embodiment of the invention.

### PREFERRED EMBODIMENT(S) FOR CARRYING OUT THE INVENTION

Hereinafter will be described first to third embodiments of the present invention in detail with reference to drawings as needed.

### First Embodiment

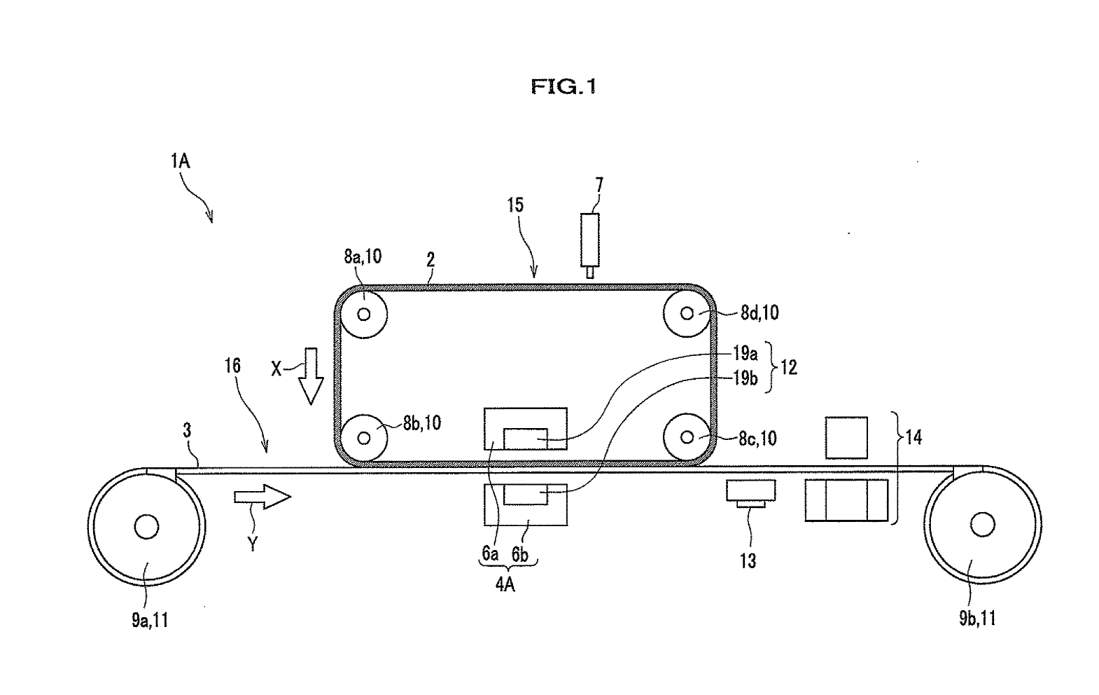

As shown in the configuration illustration of FIG. 1, a pattern transfer apparatus 1A comprises a mold carrying mechanism 10 configured to carry a mold 2 along a mold carrying route 15 predetermined, a transferred material carrying mechanism 11 configured to carry a transferred material 3 along a transferred material carrying route 16 predetermined, a press mechanism 4A configured to press the mold 2 and the transferred material 3 with each other, a mold-releasing agent supplying mechanism 7 configured to supply a mold-releasing agent to the mold 2, an information recording mechanism 12, an interpretation mechanism 13, and an after-treatment mechanism 14.

In addition, although the mold-releasing agent supplying mechanism 7 of the first embodiment is arranged to supply a mold-releasing agent to the mold 2 on the mold carrying route 15 at a zone from a roll 8d to a roll 8a, the arranged position of the mechanism 7 is not limited thereto; the mechanism 7 may be arranged on the route 15 so as to supply the mold-releasing agent at any one of a zone from a roll 8c to the roll 8d and a zone from the roll 8a to a roll 8b. Furthermore, the mold-releasing agent supplying mechanism 7 may be arranged at a plurality of places on the mold carrying route 15. Furthermore, when the mold-releasing agent supplying mechanism 7 can give the mold-releasing agent on a concave/convex pattern surface of the mold 2 and form a mold-releasing layer thereon, any configuration may be available; for example, it is possible to cite configurations of: the mold-releasing agent being immersed in the mold 2; and the mold-releasing agent being applied to the mold 2. In this connection, as an applying system, any one and combination of a spray system, an ink jet system, a dispenser system, a brush system, and the like may be available. In addition, with respect to the mold-releasing agent which is solid at a normal temperature, it is possible to adjust any one of a solution and a dispersion liquid with respective ones of a proper solvent and dispersant, and use any one of the solution and the dispersion liquid.

As the mold-releasing agent supplied from the mold-releasing agent supplying mechanism 7, a so-called non-reactive mold-releasing agent is preferable that is not covalently bonded to a chemical species on the surface of the mold 2; specifically, a fluorine mold-releasing agent is preferable. Among others, a fluorine mold-releasing agent having a polar group at a molecule end is preferable; particularly, a fluorine mold-releasing agent having at least one of a hydroxyl group, an ether group, and an ester group at a molecule end is preferable.

The mold 2 of the embodiment is configured to be formed like a belt, be annular, and thus be an endless belt-like mold. The mold 2 comprises a fine concave/convex pattern (not shown) transferred onto the transferred material 3 on an annular outer face which contacts the material 3. This concave/convex pattern is a pattern where a concave portion and a convex portion are repeatedly and continuously formed; a depth, width, and interval of the concave portion, and a height, width, and interval of the convex portion are formed in nanometer order.

In this connection, it is possible to appropriately set a concave and convex shape of the concave/convex pattern according to a usage of a fine structural body obtained by the pattern transfer apparatus 1A; for example, as the concave and convex shape, a columnar shape a hole shape, a lamellar shape, and the like can be cited. Furthermore, the concave/convex pattern may be formed over an entire periphery of the mold 2, and on a part thereof.

When a material of the mold 2 of the embodiment has a flexibility and can achieve a required strength and process accuracy, it is not specifically limited. For example, various kinds of metals, various resins, and the like can be cited. As a metal, nickel is preferable; as a resin, a polyimide resin and a photo-curing resin are preferable. Furthermore, the mold 2 thus described may be a compound lamination, wherein one of a metal such as nickel and a resin such as a polyimide resin and a base member supporting the one of the metal and the resin are integrated, wherein the one of the metal and the resin forms the concave/convex pattern in the mold 2, and wherein the base member is, for example, stainless steel, an aromatic polyamide resin (for example, KEVLAR (registered trademark) resin, and the like.

The mold carrying mechanism 10 of the embodiment comprises a plurality of rolls 8a, 8b, 8c, and 8d over which the mold 2 is hanged, and a drive mechanism (not shown) such as a stepping motor for intermittently driving the rolls 8a, 8b, 8c, and 8d by every predetermined rotation angle. The rolls 8a, 8b, 8c, and 8d of the embodiment are arranged to contact an inside of the annular mold 2.

The drive mechanism is configured to rotate each of the rolls 8a, 8b, 8c, and 8d counterclockwise (left rotation) and intermittently; thereby to intermittently rotate the mold 2 in a left rotation, and to send the mold 2 into a press mechanism 4A (described later) by every predetermined length, intermittently and endlessly. A rotation angle of the drive mechanism (not shown) of the rolls 8a, 8b, 8c, and 8d is, for example, set so that a length of the mold 2 sent into the press mechanism 4A is a predetermined length. In addition, an arrow mark where a symbol X is appended in FIG. 1 indicates a carried direction of the mold 2.

Out of the four rolls 8a, 8b, 8c, and 8d, the two rolls 8b, 8c arranged to press the mold 2 to the transferred material 3 carried by the transferred material carrying mechanism 11 (described later) have a function of: sending the mold 2 so as to contact the transferred material 3 by the roll 8b on an upstream side of the mold 2 carried; peeling off the mold 2 from the transferred material 3 by the roll 8c on an upstream side thereof. In addition, the rolls 8a, 8b, 8c, and 8d are not limited to four; when at least the function of the rolls 8b, 8c is provided, any case of three rolls and more than four rolls is also available.

The transferred material 3 of the embodiment is formed like a long belt and is formed of a thermal plastic resin film. As the thermal plastic resin, it is possible to appropriately select it according to a usage of a fine structural body obtained by the pattern transfer apparatus 1A; among others, the thermal plastic resin having a glass transition temperature Tg of 100 to 160 degrees Celsius is preferable, and specifically, for example, polystyrene, polycarbonate, polymethyl methacrylate, and the like can be cited. The transferred material 3 is wound and housed in a pay-off reel 9a of the transferred material carrying mechanism 11 described next. In addition, although the transferred material 3 of the embodiment is assumed to be a film essentially consisting of a single layer formed of the thermal plastic resin, a multilayer configuration where at least one of an outmost layer thereof may be formed of the thermal plastic resin.

The transferred material carrying mechanism 11 of the embodiment comprises: the pay-off reel 9a in which the transferred material 3 is wound and housed; a winding reel 9b configured to wind the material 3 paid off from the reel 9a; and a drive mechanism (not shown) such as a stepping motor for intermittently rotating the reel 9b by every predetermined rotation angle so as to wind at least the material 3. The drive mechanism intermittently rotates the reel 9b by every predetermined rotation angle and thereby is configured to intermittently wind the transferred material 3 by every predetermined length defined in advance. In other words, the winding reel 9b pulls out the transferred material 3 from the pay-off reel 9a according to every predetermined length through the drive mechanism and to send the material 3 into the press mechanism 4A described later. In addition, an arrow mark where a symbol Y is appended in FIG. 1 indicates a carried direction of the transferred material 3.

The drive mechanism of the winding reel 9b of the embodiment matches a timing when the mold 2 is sent into the press mechanism 4A with a timing when the transferred material 3 is sent to the press mechanism 4A in synchronization with the drive mechanism of the rolls 8a, 8b, 8c, and 8d; and the drive mechanism matches a length of the transferred material 3 sent into the press mechanism 4A with a length of the mold 2 sent into the press mechanism 4A.

That is, the pattern transfer apparatus 1A of the embodiment is configured to send the mold 2 and the transferred material 3 superimposed on each other into the press mechanism 4A. In addition, although in the embodiment only the winding reel 9b is provided with the drive mechanism, a drive mechanism configured to rotate the pay-off reel 9a in synchronization with a rotation of the reel 9b may also be provided.

Furthermore, when the mold 2 is in close contact with the transferred material 3, even when the transferred material carrying mechanism 11 is not provided with the drive mechanism, it is also possible to simultaneously carry the mold 2 and the transferred material 3 by driving the mold carrying mechanism 10 and sending the mold 2 into the press mechanism 4A. Furthermore, the transferred material carrying mechanism 11 may also comprise a tension adjustment mechanism (not shown) for adjusting so that slackening does not occur in the transferred material 3.

The press mechanism 4A of the embodiment is configured to pinch and press the mold 2 between the roll 8b and roll 8c, wherein the mold 2 travels from the roll 8b to roll 8c, and the transferred material 3 is carried so as to be superimposed on the mold 2. The press mechanism 4A comprises an upper-side press member 6a and a lower-side press member 6b arranged face to face so as to pinch the mold 2 and the transferred material 3 at the zone of the roll 8b to roll 8c; and a drive mechanism (not shown) for moving the members 6a, 6b so as to be pressed to the mold 2 and the material 3 or to be separated therefrom. In this connection, the operation of the pressing and separation of this drive mechanism is operated when carrying the mold 2 and the transferred material 3 is stopped.

Furthermore, a heater (not shown) is built in the upper-side press member 6a. The heater heats the transferred material 3 (thermal plastic resin) through the mold 2 pressed thereto, and thereby, up to a temperature equal to or more than the glass transition temperature Tg. In addition, according to the embodiment, although it is assumed that the heater is arranged only at the upper-side press member 6a, a configuration of arranging the heater only at the lower-side press member 6b may also be available, and a configuration of arranging the heaters at both of the members 6a, 6b may also be available.

According to the press mechanism 4A thus described, it is possible to transfer the fine concave/convex pattern of the mold 2 onto the transferred material 3.

The information recording mechanism 12 of the embodiment comprises an upper-side press member 19a and a lower-side press member 19b arranged side by side with the upper-side press member 6a and the lower-side press member 6b of the press mechanism 4A, respectively.

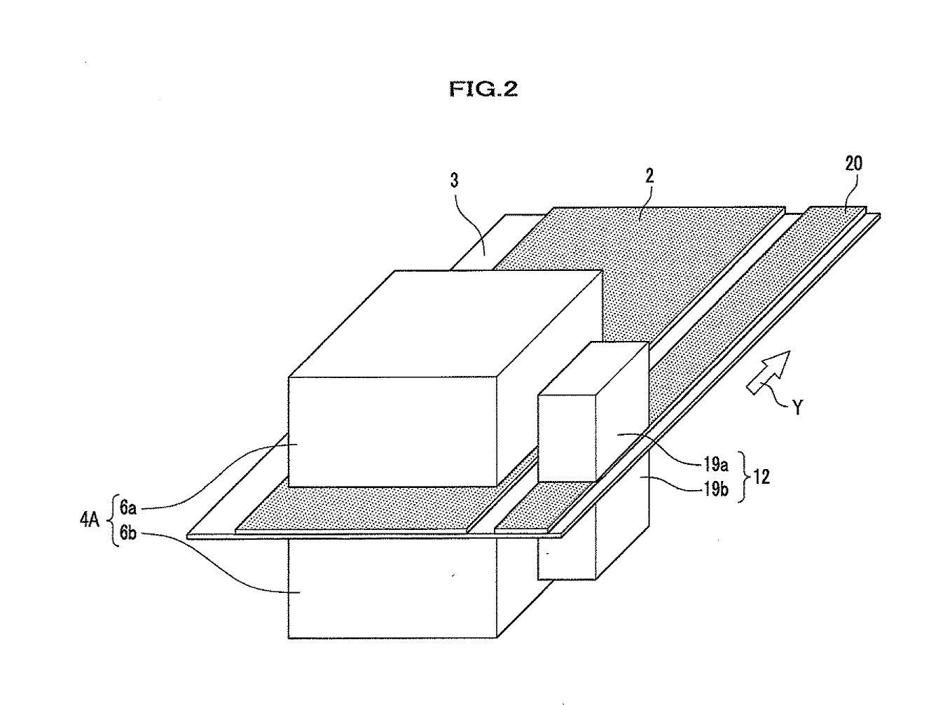

Next as shown in FIG. 2, the upper-side press member 19a and the lower-side press member 19b are configured to pinch and press the transferred material 3 and an information recording mold 20 superimposed thereon so as to travel together with the mold 2. Then a heater is arranged at least one of the upper-side press member 19a and the lower-side press member 19b. Then the upper-side press member 19a and the lower-side press member 19b pinch and press the transferred material 3 and the information recording mold 20 at a predetermined timing and are thereby configured to record information such as a character and a symbol by imprinting the information at a position associated with an area of the transferred material 3 where the concave/convex pattern is transferred onto the area.

In addition, the information recording mechanism 12 of the embodiment is not limited to the configuration of the upper-side press member 19a and the lower-side press member upper-side 19b; information may also be recorded on a surface of the transferred material 3, for example, by a method of sticking a seal, where a desired character and symbol, and magnetic information are written, other than methods of printing by ink jet, imprinting by a seal, and a direct depiction by a scanning laser. Also the position of the information recording mechanism 12 is not limited to the side-by-side position with the press mechanism 4A; it is also possible to arrange the mechanism 4A at any position on the transferred material carrying route 16.

The interpretation mechanism 13 of the embodiment is arranged in a direction where the transferred material 3 is carried, wherein predetermined information is recorded in the material 3 by the information recording mechanism 12. The interpretation mechanism 13 is provided to read information such as a character and a symbol recorded in the transferred material 3 and reads the character and the symbol, for example, by an imaging device such as a camera, and a reader of magnetic information.

The after-treatment mechanism 14 of the embodiment is arranged in a direction where predetermined information is read by the interpretation mechanism 13. The after-treatment mechanism 14 comprises, for example, a lamp for irradiating a light of a predetermined wavelength, a heater, a mechanism for supplying a predetermined gas and a predetermined liquid material to the surface of the transferred material 3, and the like; other than a punching machine for punching an area of the material 3 where the concave/convex pattern is transferred onto the area. In addition, these after-treatment mechanisms 14 are controlled so that operations are defined, respectively, based on any of the character and the symbol read by the interpretation mechanism 13. For example, when the after-treatment mechanism 14 of the embodiment is the punching machine, it is possible to change a punching position of the transferred material 3 through information read by the interpretation mechanism 13 and, according to the information read, to classify each piece portion of the material 3, which is obtained by punching. For example, as described above, when a mold-releasing treatment is performed once per a certain number of times when the concave/convex pattern is transferred (hereinafter referred to as “pattern transfer times” as needed”), an amount of a mold-releasing agent adhered to the surface of the transferred material 3 differs in some cases, depending on a number of the pattern transfer times elapsing from the mold-releasing treatment. Consequently, it is possible to collect each piece portion of the material 3 by the steps of: recording the number of the pattern transfer times elapsing from the mold-releasing treatment by the information recording mechanism 12; reading the recorded information by the interpretation mechanism 13; and selecting the recorded information by the after-treatment mechanism 14 (punching machine). At this time, when only the piece portion where a condition meeting a requirements specification of a product (component), it is possible to automatically select and obtain only the product whose property is uniform and to stabilize a performance of the product obtained by transferring the concave/convex pattern onto the transferred material 3.

Furthermore, the after-treatment mechanism 14 is not limited to the punching machine thus described and, for example, may also be a mechanism for performing an after-treatment of applying a protective coating to an area of the transferred material 3 where the concave/convex pattern is transferred.

Furthermore, it is possible to transfer recorded information onto the transferred material 3 by the steps of: arraying and forming side by side in the information recording mold 20 a plurality of pieces of the recorded information, which are transferred onto the material 3; and moving the mold 20 by a movement mechanism (not shown) so that an area, where desired recorded information of the mold 20 is provided in transferring the concave/convex pattern, is pressed to the material 3 by the upper-side press member 19a and the lower-side press member 19b.

Furthermore, as shown in FIG. 2, although the mold 2 and the information recording mold 20 are arranged on a same surface of the transferred material 3, those may also be arranged on surfaces (obverse and reverse) of the material 3 opposed with each other, respectively. Furthermore, although the mold 2 and the information recording mold 20 are arranged only on the same surface of the transferred material 3, those may also be arranged on the surfaces of the transferred material 3, respectively; or both of those may also be arranged on one of the surfaces of the material 3. Other than these, without using the information recording mold 20, it is also possible to record information, for example, by the steps of: building in a seal member, by which recorded information is changeable; and imprinting the recorded information in the transferred material 3 by the seal member so that the member is arranged on a surface of at least one of the upper-side press member 19a and the lower-side press member 19b which the surface contacts the material 3.

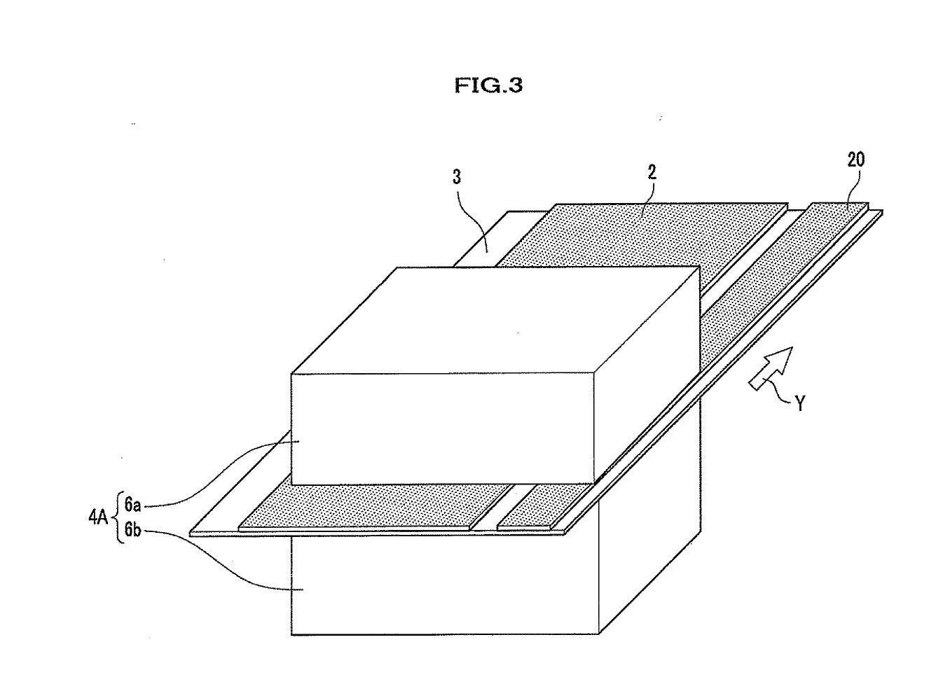

Furthermore, in FIG. 2, although the example has been shown that the information recording mechanism 12 essentially consists of the press member and controls to record the information, independently of the press mechanism 4A for transferring the concave/convex pattern, it is also possible as shown in FIG. 3, which shows a partial perspective view of a modification example of an information recording mechanism, to record required information by the steps of: extending the upper-side press member 6a and the lower-side press member 6b of the press mechanism 4A; and pressurizing the information recording mold 20 in one lump. Furthermore, without using the information recording mold 20, it is also available to build such a seal member as aforementioned in at least one of the upper-side press member 6a and the lower-side press member 6b corresponding to the position of the mold 20 and to simultaneously transfer the concave/convex pattern by the mold 2 and perform imprinting by the seal member built in.

### Second Embodiment

Next will be described a second embodiment of the invention in detail with reference to drawings as needed. In addition, in the embodiment, with respect to a component element similar to that in the first embodiment, a same symbol will be appended, and a detailed description thereof will be omitted.

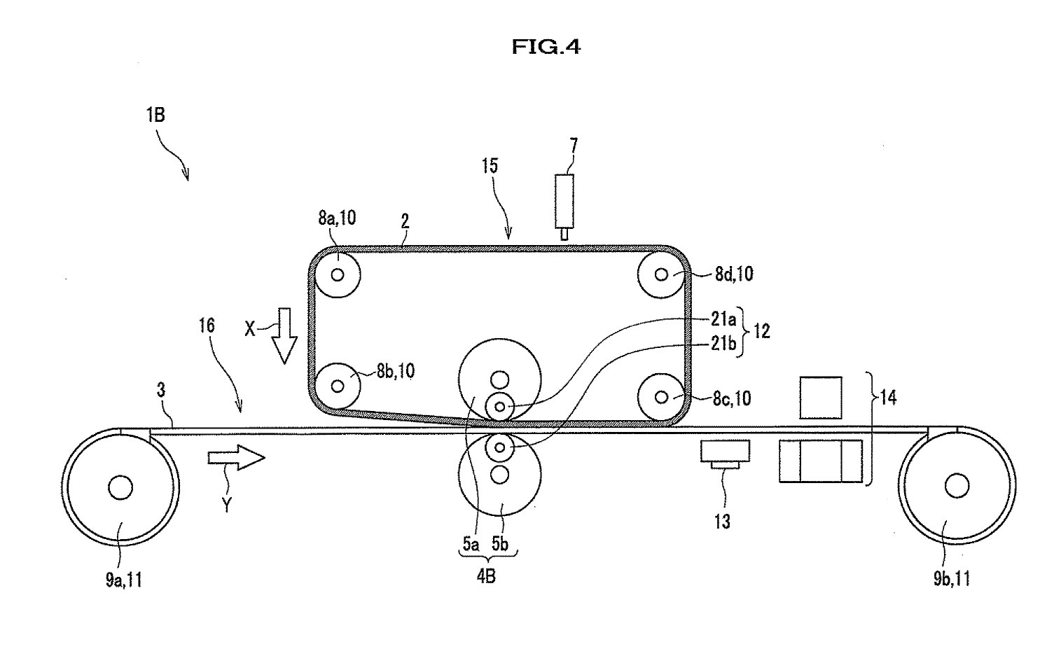

As shown in FIG. 4 of a configuration drawing of the second embodiment, a pattern transfer apparatus 1B is configured similarly to the pattern transfer apparatus 1A except that the apparatus 1B comprises: a press mechanism 4B configured with the upper-side roll 5a and the lower-side roll 5b, instead of the press mechanism 4A configured with the upper-side press member 6a and the lower-side press member 6b shown in FIG. 1; and the information recording mechanism 12 configured with an upper-side roll 21a and a lower-side roll 21b described later, instead of the information recording mechanism 12 configured with the upper-side press member 19a and the lower-side press member 19b. In this connection, although the heater is assumed to be at the upper-side roll 5a, the heater may be arranged at least one of the upper-side roll 5a and the lower-side roll 5b.

The pattern transfer apparatus 1B is configured so that the mold 2 and the transferred material 3 are supplied and pressed, wherein those are superimposed on each other between the upper-side roll 5a rotating counterclockwise (left rotation) and the lower-side roll 5b rotating clockwise (right rotation).

The pattern transfer apparatus 1B can bring out the action and effect of the pattern transfer apparatus 1A of the first embodiment and also the following action and effect:

According to the pattern transfer apparatus 1B thus described, it is possible to continuously send the mold 2 and the transferred material 3 into the pattern transfer apparatus 1B and form the concave/convex pattern on the material 3. Accordingly, the pattern transfer apparatus 1B can increase a transfer speed of the concave/convex pattern in comparison with the pattern transfer apparatus 1A (see FIG. 1) of the first embodiment comprising the press mechanism 4A of a stamp system.

In FIG. 4 symbols 21a and 21b represent an upper-side roll and a lower-side roll, respectively, as the information recording mechanism 12.

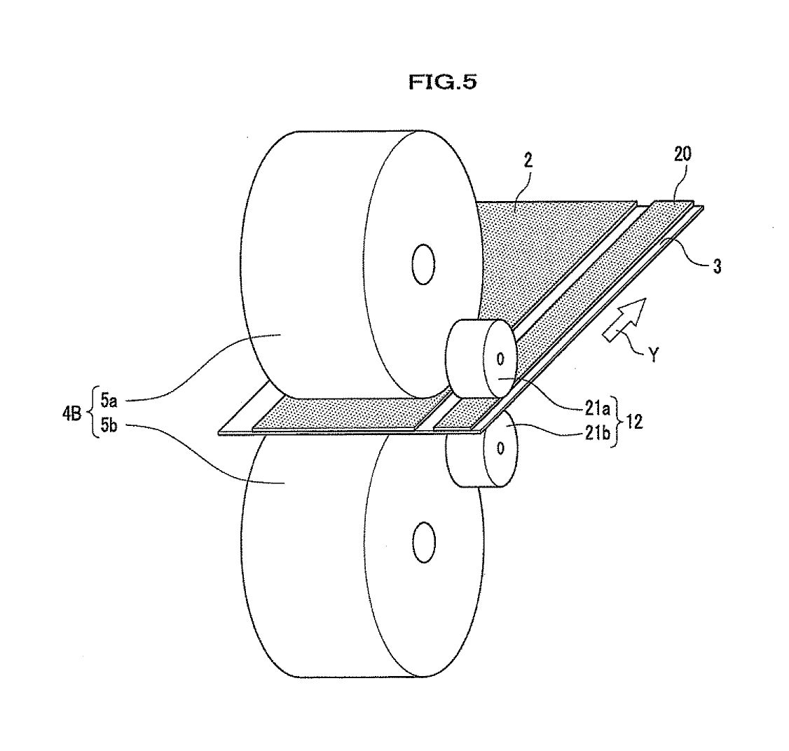

Next as shown in FIG. 5, the upper-side roll 21a and the lower-side roll 21b are configured to pinch and press the transferred material 3 and the information recording mold 20 superimposed on the material 3 so as to travel side by side with the mold 2. Then the heater is provided at least one of the upper-side roll 21a and lower-side roll 21b. Then by pinching and pressing the transferred material 3 and the information recording mold 20 at a predetermined timing, the pattern transfer apparatus 1B is configured to record information such as a character and a symbol by imprinting the information at a position associated with an area of the material 3 where the concave/convex pattern is transferred.

Furthermore, it is possible to array and form a plurality of pieces of recorded information, which are transferred onto the transferred material 3, in the information recording mold 20; to move the mold 20 by a movement mechanism (not shown) throughout an area, where desirable recorded information of the mold 20 is provided, so as to be pressed to the material 3 by the upper-side roll 21a and lower-side roll 21b when the concave/convex pattern is transferred onto the material 3; and to transfer the recorded information thereon.

Furthermore, as shown in FIG. 5, although the mold 2 and the information recording mold 20 are arranged on a same surface of the transferred material 3, those may also be arranged on the surfaces (obverse and reverse) of the material 3 opposed with each other, respectively. Furthermore, although the mold 2 and the information recording mold 20 are arranged only on a same surface of the transferred material 3, the mold 2 and the mold 20 may also be arranged on the surfaces of the transferred material 3, respectively; or both of the mold 2 and the mold 20 may also be arranged on one of the surfaces of the material 3.

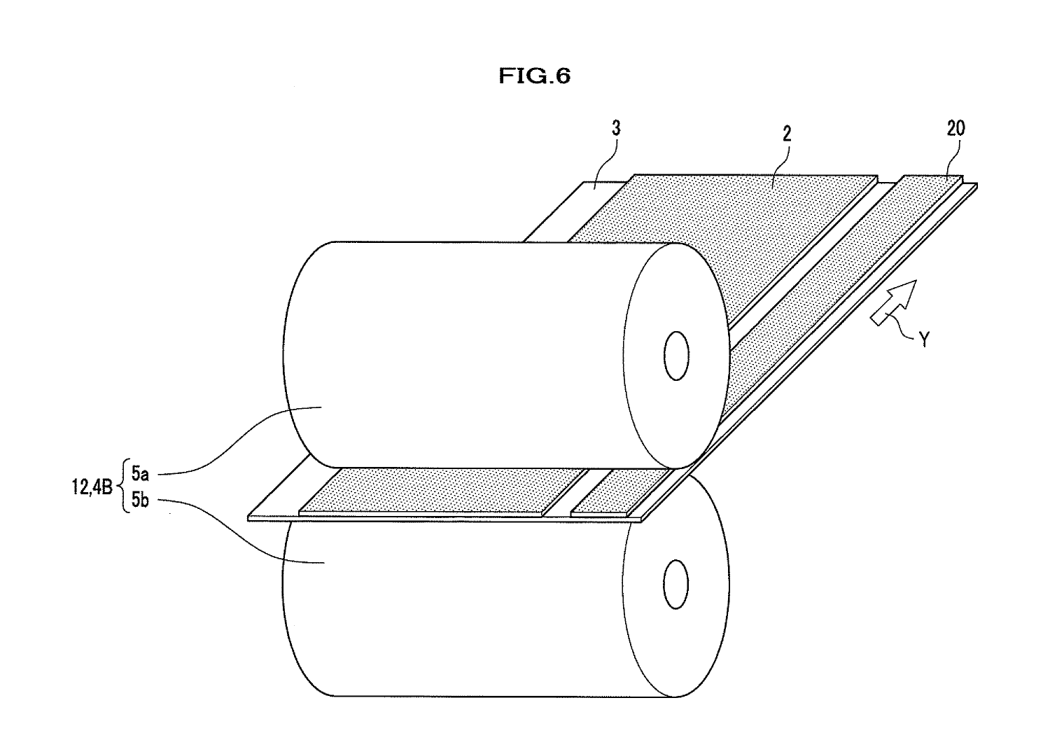

Furthermore, although FIG. 5 shows an example that the information recording mechanism 12 essentially consists of the upper-side roll 21a and the lower-side roll 21b and controls to record information, independently of the press mechanism 4B for transferring the concave/convex pattern, it is possible as shown in FIG. 6, which shows a partial perspective view of a modification example of the information recording mechanism 12, to record required information also by extending the upper-side roll 21a and lower-side roll 21b of the press mechanism 4B and by pressurizing the information recording mold 20 in one lump. Furthermore, without using the information recording mold 20, it is also available to build such a seal member as aforementioned in at least one of the roll 21a and the roll 21b corresponding to a position of the mold 20 and to simultaneously transfer the concave/convex pattern by the mold 2 and perform imprinting by the seal member built in.

In addition, although in FIG. 5 the press mechanism 4B and the information recording mechanism 12 are arranged approximately in parallel to each other, one of a place where the concave/convex pattern is transferred and a position where information is recorded may also be arranged to be displaced along the send direction Y of the material 3. In this case, because in the embodiment the transferred material 3 is continuously carried, it is required that the information is recorded at a position associated with an area, where the concave/convex pattern is transferred onto the material 3 by the pattern transfer apparatus 1B, at a timing when the area reaches the position of the information recording mechanism 12. That is, it is preferable that a period of the concave/convex pattern included in the mold 2 and that of the concave/convex pattern included in the information recording mold 20 are same; and that those concave/convex patterns are arranged so that a period of one of those corresponds to integer times of that of the other.

Also in the embodiment similarly to the first embodiment, when the after-treatment mechanism 14 in FIG. 4 is a punching machine, it is possible to change a punched position of the transferred material 3 through the information read by the interpretation mechanism 13 and according to the information read, to classify each piece portion of the material 3 which is obtained by punching. At this time, when only piece portion where a condition meeting the requirements specification of a product (component), it is possible to automatically select and obtain only the product whose property is uniform and to stabilize the performance of the product obtained by transferring the concave/convex pattern onto the transferred material 3.

Furthermore, the after-treatment mechanism 14 is not limited to the punching machine thus described and, for example, may also be a mechanism for performing an after-treatment of applying a protective coating to an area where the concave/convex pattern is transferred onto the transferred material 3.

### Third Embodiment

Next will be described a third embodiment of the invention in detail with reference to drawings as needed. In addition, in the embodiment, with respect to a component element similar to that in the second embodiment, a same symbol will be appended, and a detailed description thereof will be omitted.

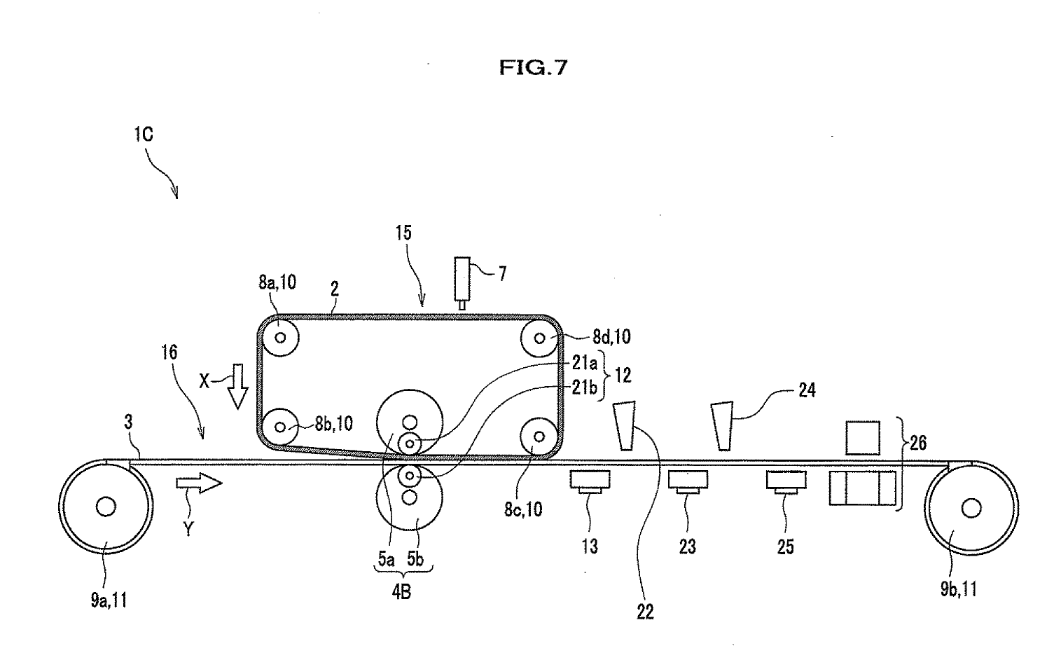

As shown in FIG. 7 of a configuration drawing of the third embodiment, a pattern transfer apparatus 1C is provided, as the after-treatment mechanism 14 in the configuration of FIG. 4, with: a light irradiation mechanism 22 configured to irradiate a light of a predetermined wavelength onto the transferred material 3; a purification mechanism 24 configured to spray a solvent having an ability of decomposing a mold-releasing adhered to the material 3; a collection mechanism 26 configured to classify, punch, and collect an area of the material 3 where the concave/convex pattern is transferred; and interpretation mechanisms 13, 23, and 25 configured to read information and feed back it to each of the mechanisms 22, 24, and 26 provided thereto, respectively.

The pattern transfer apparatus 1C may also control such an irradiation intensity and irradiation time of the light by the steps of recording information by the information recording mechanism 12 on the surface of the transferred material 3 where the concave/convex pattern is transferred by the press transfer apparatus 4B; reading the recorded information by the interpretation mechanism 13; and feeding back the information to the light irradiation mechanism 22. At this time, it is possible to equalize an aspect of the surface of the transferred material 3 just after the light irradiation by the steps of: selecting a light source which irradiates a light of a wavelength having an ability of decomposing a mold-releasing agent; and controlling a condition of the light irradiation, depending on an adhesion amount of the mold-releasing agent just after the concave/convex pattern being transferred. Thus, because it is possible to obtain only a product (component) whose property is uniform so as to meet the requirements specification of the product, it is possible to stabilize the performance of the product.

Furthermore, the pattern transfer apparatus 1C may also read the information by the interpretation mechanism 23, feed back the information to the purification mechanism 24, and control such a spray amount and spray time of the solvent. At this time, by controlling the spray conditions of the solvent just after the concave/convex pattern being transferred, it is possible to equalize the aspect of the surface of the transferred material 3 just after the light irradiation. Therefore, similarly to the aforementioned case, it is possible to stabilize the performance of a product (component).

Moreover, it is possible to read the information by the interpretation mechanism 25, feed back the information to the collection mechanism 26, classify and punch one of a required area and an unnecessary area, and collect it. Therefore, similarly to the first embodiment and the second embodiment, it is possible to automatically select and obtain only a product (component) whose property is uniform and to stabilize the performance of the product obtained by transferring the concave/convex pattern onto the transferred material 3.

Thus although the first to third embodiments have been described, the invention is not limited thereto and can be performed in various embodiments.

As the information recorded on the transferred material 3 by the information recording mechanism 12 of the first to third embodiments, the number of the pattern transfer times after the mold-releasing treatment of the mold 2 is cited, the invention is not limited to the mold-releasing treatment; similarly, it is also available to record a number of elapse times of the pattern transfer after any treatment of one of the mold 2 and the transferred material 3 once per a certain number of the pattern transfer times, and to feed back the number of the elapse times to a treatment performed by the after-treatment mechanism 14,

Furthermore, although in the first to third embodiments the number of the elapse times of the pattern transfer are assumed to be the recorded information, the invention is not limited thereto; it is also available to record an optional pretreatment condition and the like and to feed back those to the after-treatment mechanism 14.

Furthermore, with respect to the number of the elapse times and the optional pretreatment condition and the like aforementioned, it is also available to record not only one of those singly but also a plurality of pieces of information therewith.

Furthermore, when not only the recorded information fed back to the after-treatment mechanism 14 but also, for example: a date; a time; any of temperature and humidity of a place where the concave/convex pattern is transferred; any lot information of the molds 2, 20 and the transferred material 3 are recorded together, it is useful to investigate a history of a product (component) in case of a defect occurring in the product.

What is claimed is:

1. A pattern transfer apparatus for pressing a mold having a fine concave/convex pattern onto a transferred material, peeling off the mold from the transferred material, and transferring the concave/convex pattern onto a surface of the transferred material, the apparatus comprising:
a pretreatment mechanism configured to perform a predetermined surface treatment to at least one of the mold and the transferred material before the concave/convex pattern is transferred;
an information recording mechanism configured to record information of the surface treatment performed by the pretreatment mechanism at a position associated with an area of the transferred material where the concave/convex pattern is transferred onto the area;
an interpretation mechanism configured to read the recorded information; and
an after-treatment mechanism configured to perform a predetermined after-treatment to the area where the concave/convex pattern is transferred, based on the information interpreted by the interpretation mechanism.

2. The pattern transfer apparatus according to claim 1, wherein the information recording mechanism records the information by at least one of printing, imprinting, and a sticker.

3. The pattern transfer apparatus according to claim 1, wherein the mold is formed like a belt.

4. The pattern transfer apparatus according to claim 2, wherein the mold is formed like a belt.

5. The pattern transfer apparatus according to claim 1, wherein the treatment mechanism is a mold-releasing agent supply mechanism configured to supply a mold-releasing agent.

6. The pattern transfer apparatus according to claim 2, wherein the treatment mechanism is a mold-releasing agent supply mechanism configured to supply a mold-releasing agent.

7. The pattern transfer apparatus according to claim 3, wherein the treatment mechanism is a mold-releasing agent supply mechanism configured to supply a mold-releasing agent.

8. The pattern transfer apparatus according to claim 4, wherein the treatment mechanism is a mold-releasing agent supply mechanism configured to supply a mold-releasing agent.

9. The pattern transfer apparatus according to claim 1, wherein the after-treatment mechanism comprises at least one of:
a collection mechanism configured to punch the area of the transferred material, where the concave/convex pattern is transferred onto the area, and separate and collect the punched area;
a light irradiation mechanism configured to irradiate a light of a predetermined wavelength at the area; and
a purification mechanism configured to supply any of a predetermined gas and a predetermined liquid to the area and purify the area.

10. The pattern transfer apparatus according to claim 2, wherein the after-treatment mechanism comprises at least one of:
a collection mechanism configured to punch the area of the transferred material, where the concave/convex pattern is transferred onto the area, and separate and collect the punched area;
a light irradiation mechanism configured to irradiate a light of a predetermined wavelength at the area; and
a purification mechanism configured to supply any of a predetermined gas and a predetermined liquid to the area and purify the area.

11. The pattern transfer apparatus according to claim 3, wherein the after-treatment mechanism comprises at least one of:
a collection mechanism configured to punch the area of the transferred material, where the concave/convex pattern is transferred onto the area, and separate and collect the punched area;
a light irradiation mechanism configured to irradiate a light of a predetermined wavelength at the area; and
a purification mechanism configured to supply any of a predetermined gas and a predetermined liquid to the area and purify the area.

12. The pattern transfer apparatus according to claim 4, wherein the after-treatment mechanism comprises at least one of:
a collection mechanism configured to punch the area of the transferred material, where the concave/convex pattern is transferred onto the area, and separate and collect the punched area;
a light irradiation mechanism configured to irradiate a light of a predetermined wavelength at the area; and
a purification mechanism configured to supply any of a predetermined gas and a predetermined liquid to the area and purify the area.

13. The pattern transfer apparatus according to claim 5, wherein the after-treatment mechanism comprises at least one of:
a collection mechanism configured to punch the area of the transferred material, where the concave/convex pattern is transferred onto the area, and separate and collect the punched area;
a light irradiation mechanism configured to irradiate a light of a predetermined wavelength at the area; and
a purification mechanism configured to supply any of a predetermined gas and a predetermined liquid to the area and purify the area.

14. The pattern transfer apparatus according to claim 6, wherein the after-treatment mechanism comprises at least one of:
a collection mechanism configured to punch the area of the transferred material, where the concave/convex pattern is transferred onto the area, and separate and collect the punched area;
a light irradiation mechanism configured to irradiate a light of a predetermined wavelength at the area; and
a purification mechanism configured to supply any of a predetermined gas and a predetermined liquid to the area and purify the area.

15. The pattern transfer apparatus according to claim 7, wherein the after-treatment mechanism comprises at least one of:
a collection mechanism configured to punch the area of the transferred material, where the concave/convex pattern is transferred onto the area, and separate and collect the punched area;
a light irradiation mechanism configured to irradiate a light of a predetermined wavelength at the area; and
a purification mechanism configured to supply any of a predetermined gas and a predetermined liquid to the area and purify the area.

16. The pattern transfer apparatus according to claim 8, wherein the after-treatment mechanism comprises at least one of:
a collection mechanism configured to punch the area of the transferred material, where the concave/convex pattern is transferred onto the area, and separate and collect the punched area;
a light irradiation mechanism configured to irradiate a light of a predetermined wavelength at the area; and
a purification mechanism configured to supply any of a predetermined gas and a predetermined liquid to the area and purify the area.

17. A pattern transfer method for pressing a mold having a fine concave/convex pattern onto a transferred material, peeling off the mold from the transferred material, and transferring the concave/convex pattern onto a surface of the transferred material, the method comprising:
a process of performing a predetermined surface treatment to at least one of the mold and the transferred material before the concave/convex pattern is transferred;
an information recording process of recording information of the surface treatment performed by the pretreatment process at a position associated with an area of the transferred material where the concave/convex pattern is transferred onto the area;
an interpretation process of reading the recorded information; and
an after-treatment process of performing a predetermined after-treatment to the area where the concave/convex pattern is transferred, based on the information interpreted by the interpretation process.

18. The pattern transfer method according to claim 17, wherein the information recording process records the information by at least one of printing, imprinting, and a sticker.

19. The pattern transfer method according to claim 18, wherein the treatment process is a mold-releasing agent supplying process of supplying a mold-releasing agent.

20. The pattern transfer method according to claim 19, wherein the treatment process is a mold-releasing agent supplying process of supplying a mold-releasing agent.

21. The pattern transfer method according to claim 17, wherein the after-treatment process comprises at least one of:
a collection process of punching the area of the transferred material where the concave/convex pattern is transferred onto the area, and separating and collecting the punched area;
a light irradiation process of irradiating a light of a predetermined wavelength at the area; and
a purification process of supplying any of a predetermined gas and a predetermined liquid to the area and purifying the area.

22. The pattern transfer method according to claim 18, wherein the after-treatment process comprises at least one of:
a collection process of punching the area of the transferred material where the concave/convex pattern is transferred onto the area, and separating and collecting the punched area;
a light irradiation process of irradiating a light of a predetermined wavelength at the area; and
a purification process of supplying any of a predetermined gas and a predetermined liquid to the area and purifying the area.

23. The pattern transfer method according to claim 19, wherein the after-treatment process comprises at least one of:
a collection process of punching the area of the transferred material where the concave/convex pattern is transferred onto the area, and separating and collecting the punched area;
a light irradiation process of irradiating a light of a predetermined wavelength at the area; and
a purification process of supplying any of a predetermined gas and a predetermined liquid to the area and purifying the area.

24. The pattern transfer method according to claim 20, wherein the after-treatment process comprises at least one of:
a collection process of punching the area of the transferred material where the concave/convex pattern is transferred onto the area, and separating and collecting the punched area;
a light irradiation process of irradiating a light of a predetermined wavelength at the area; and
a purification process of supplying any of a predetermined gas and a predetermined liquid to the area and purifying the area.
